(19) United States
(12) Patent Application Publication
(10) Pub. No.: US 2005/0015718 A1
(43) Pub. Date: Jan. 20, 2005

(54) Method and system for client aware content aggregation and rendering in a portal server

(76) Inventors: Mihir Y. Sambhus, Milpitas, CA (US); Wun-Mai J. Chang, San Jose, CA (US); Gregory J. Ziebold, Superior, CO (US); Luu D. Tran, Santa Clara, CA (US)

Correspondence Address: OSHA & MAY L.L.P./SUN, 1221 MCKINNEY, SUITE 2800, HOUSTON, TX, 77010, US

(21) Appl. No.: 10/622,047

(22) Filed: Jul. 16, 2003

(51) Int. Cl. G06F 15/00

(52) U.S. Cl. 715/513

(57) ABSTRACT

A method and system for client aware content aggregation and rendering in a portal server. The method includes the step of receiving content from a plurality of channels. The content from the channels is aggregated using an aggregator. The aggregator is configured to process the content using a first markup language. The aggregated content is processed using a rendering engine. The rendering engine is configured to output the aggregated content in a second markup language tailored for a client device. The method further includes outputting the aggregated content in the second markup language to the client device.

This application is related to commonly assigned copending U.S. patent application “A METHOD AND SYSTEM FOR CUSTOMIZABLE CLIENT AWARE CONTENT SELECTION AND RENDERING IN A PORTAL SERVER” by Sambhus et al., filed on ______, Ser. No. ______, Attorney Docket No. SUN-P030087, and “A METHOD AND SYSTEM FOR RESPONSE BUFFERING IN A PORTAL SERVER FOR CLIENT DEVICES” by Batchu et al., filed on ______, Ser. No. ______, Attorney Docket No. SUN-P030062, which are both incorporated herein in their entirety.

### TECHNICAL FIELD

The present invention relates generally to portal servers and, in particular, to portal servers having client aware content aggregation suitable for mobile applications.

### BACKGROUND ART

The use of Web portals has become widespread for obtaining information, news, entertainment, and the like, via the World Wide Web. A Web portal is generally a Web “supersite” that provides a variety of services including Web searching, news, white and yellow pages directories, free e-mail, discussion groups, online shopping and links to other sites. The Web portal term is generally used to refer to general purpose sites, however, it is increasingly being used to refer to vertical market sites that offer the same services, but only to a particular industry such as banking, insurance or computers, or fulfill specific needs for certain types of users, for example, business travelers who are often away from their office or their primary point of business.

Certain types of Web portals have evolved into customized, user type specific sources of information. One example would be a corporate Web site, wherein an internal Web site (intranet) provides proprietary, enterprise-wide information to company employees as well as access to selected public Web sites and vertical-market Web sites (suppliers, vendors, etc.). Such a Web site would typically include a customized search engine for internal documents as well as the ability to customize the portal page for different user groups and individuals. Access to such customized Web sites by business travelers, or other types of users who require concise prompt access to information, is a highly sought-after goal. For example, for a mobile user (e.g., business traveler), it would be very advantageous to obtain wireless access to a Web portal via a portable handheld device, such as a cell phone or a wireless PDA. However, presentation of information on the small screens typical with such portable handheld devices requires customization of the Web portal and the formatting of the data it provides.

Standards have been developed to provide a widely used method of formatting data for the smaller screens of portable handheld devices. One such standard is WML (Wireless Markup Language). WML is a tag-based language used in the Wireless Application Protocol (WAP). WML is an XML document type allowing standard XML and HTML tools to be used to develop WML applications. WAP is a standard for providing cellular phones, pagers and other handheld devices with secure access to e-mail and text-based Web pages. WAP provides a complete environment for wireless applications that includes a wireless counterpart of TCP/IP and a framework for telephony integration such as call control and phone book access. WAP features the Wireless Markup Language (WML) and is a streamlined version of HTML for small screen displays. It also uses WMLScript, a compact JavaScript-like language that runs in limited memory. WAP is designed to run over all the major wireless networks in place now and in the future.

A typical prior art portal server arrangement is shown in FIG. 1A and is indicated by the general reference character 100. This high-level representation of portal server operation includes Access Device 102, Portal Server 104, Identity Server 106, and Application/Web Server 108. In standard operation, a user logs into Identity Server 106 by giving a suitable user name and password. Once the user has been authenticated, a request made from Access Device 102 can be forwarded to Portal Server 104 and content supplied by Application/Web Server 108 can be sent to the Access Device as a Front Page. A given front page may display several different channels of content. An example of channels as arranged in a front page or personalized web page display is indicated by the general reference character 120 shown in FIG. 1B. One channel may include Mail 122 while another may include a calendar function, for example. Back-end standard server 124 may be any type of mail server, such as “Exchange,” that can be used to convey mail content. FIG. 1C shows an example of a channel 140 with the title “Mail” that may be part of a front page requested by a user. The display or “markup” may contain a minimize button 142 and/or a close button 144. The content 146 can be generated by a provider and may include such items as the number of total messages and the number of unread messages, for example. A container may include information from a number of such content providers for a variety of channels.

As the number of different types of access devices proliferates, conventional portal servers are not equipped to provide the appropriate markup for each type of device. Each cellular phone or personal digital assistant (PDA) device understands a different type of markup language. For example, a PDA may have a completely different display than a mobile phone. Examples of types of markup language include HyperText Markup Language (HTML) commonly used for PC-based applications, Wireless Markup Language (WML) for mobile applications, Compact HTML (CHTML) for small information appliances, and Extensible HTML (XHTML) as an HTML alternative language.

The default path is to use a PC-based HTML type of markup, but this does not work on many non-PC access devices. In a mobile phone type of access device, for example, there is not a standard or universal type of markup language. There are several different types of markup language with each phone manufacturer and/or service provider using its own markup for a preferred “look-and-feel” of the device. In conventional portal server approaches, it is very difficult and not cost effective to handle the thousands of different access devices currently available. Because of this current difficulty and the expectation that the number of different markups required is only likely to increase, there must be a way to handle different types of access devices without having to develop a device-specific container for each. Further, it would be advantageous to have the ability to present a different markup as desired to the content displayed on a given access device.

It would be desirable to have a more intelligent system so that, based on the type of access device detected, content can be supplied in an appropriate type of markup. Although tools are in place (e.g., wirelessly connected portable handheld devices, WML and WAP based communications standards, customized Web portals, etc.) to provide customized, application specific, information to business travelers and other various types of users via portable handheld devices, existing prior art applications and methods are still generally targeted towards desktop implementations. The number of individually customized and tailored information delivery mechanisms is limited.

### DISCLOSURE OF THE INVENTION

The present invention provides a solution that can customize information presented from a Web site or a Web portal with respect to a particular device of an individual user. The present invention automatically formats the information in accordance with the requirements of a particular client device.

In one embodiment, the present invention is implemented as a method for client aware content aggregation and rendering in a portal server. The method includes the step of receiving content from a plurality of channels. The content from the channels is aggregated using an aggregator. The aggregator is configured to process the content using a first markup language, for example, ensuring the appropriate tags are included in the aggregated content. In one embodiment, the first markup language is AML (abstract markup language). The aggregated content is processed using a rendering engine. The rendering engine is configured to output the aggregated content in a second markup language tailored for a client device. In one embodiment, the second markup language is device specific, being tailored for the particular requirements of a particular client device. The processed aggregated content in the second markup language is then output to the client device. As appropriate to the circumstances of the user, the client device can be a portable handheld device such as a cellular phone, a wirelessly connected PDA (personal digital assistant), or the like.

In another embodiment, the present invention is implemented as a method of processing a request for client aware content in a wireless portal server that includes the steps of: (i) providing a first channel having content in a generic markup language; (ii) providing a second channel having content in the generic markup language; (iii) aggregating the first channel content with the second channel content to form a first document in the generic markup language; and (iv) post-processing the first document to form a second document in a device-specific markup language.

### BRIEF DESCRIPTION OF THE DRAWINGS

The accompanying drawings, which are incorporated in and form a part of this specification, illustrate embodiments of the invention and, together with the description, serve to explain the principles of the invention:

Prior art FIG. 1A is a diagram of a conventional portal server in relation to an accessing device.

Prior art FIG. 1B is a diagram of a conventional front page presented on an access device.

Prior art FIG. 1C is a diagram of a conventional channel with content from a provider.

FIG. 2 is a block diagram of a portal server interface structure according to one embodiment of the present invention.

FIG. 3 is a block diagram of an example rendering container provider for all rendering type channels according to one embodiment of the present invention.

FIG. 4 is a block diagram of an example rendering container provider for two rendering type channels and one non-rendering type channel according to one embodiment of the present invention.

FIG. 5 is a block diagram of an example WML container provider for two non-rendering type channels and one rendering type channel according to one embodiment of the present invention.

FIG. 6 is a flow chart of a method of processing a request for content according to one embodiment of the present invention.

### DETAILED DESCRIPTION OF THE INVENTION

Reference will now be made in detail to the embodiments of the invention, a method for using user location information to customize information retrieved via a server, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Notation and Nomenclature

Some portions of the detailed descriptions which follow are presented in terms of procedures, steps, logic blocks, processing, and other symbolic representations of operations on data bits within a computer memory. These descriptions and representations are the means used by those skilled in the data processing arts to convey most effectively the substance of their work to others skilled in the art. A procedure, computer executed step, logic block, process, etc., are here, and generally, conceived to be self-consistent sequences of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing,” “examining,” “accessing,” “routing,” “determining,” “transmitting,”—storing,” or the like, refer to the action and processes of a computer system, or similar electronic computing device, that manipulates and transforms data represented as physical (electronic) quantities within the computer system's registers and memories into other data similarly represented as physical quantities within the computer system registers or memories or other such information storage, transmission, or display devices

Embodiments of the present invention function in part to solve problems associated with handling content requests from one of a large number of possible devices. Embodiments the present invention provide a way to transfer the content information from a web or application server by using a generic or Abstract Markup Language (AML) and a “Rendering Container”. Using AML and converting to an appropriate device-specific language using a “Rendering Engine” allows a portal server to accommodate conceivable access devices. Implementations of this approach can include software that can be installed on a server, such as a portal server.

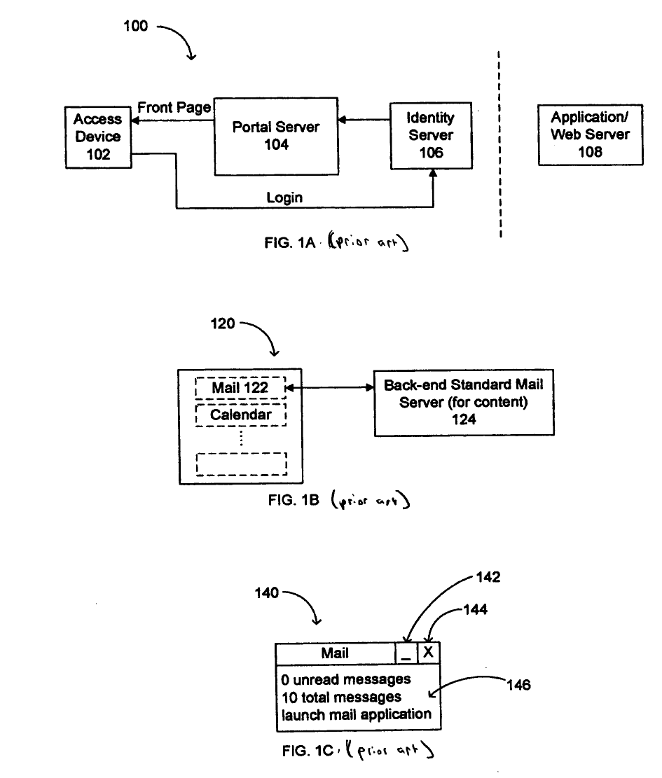

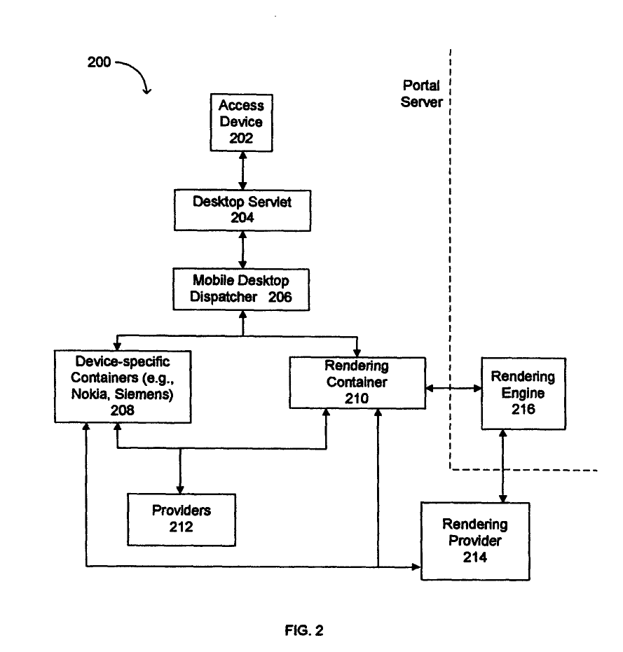

Referring now to FIG. 2, a block diagram of a portal server interface structure according to an embodiment is shown and indicated by the general reference character 200. Access Device 202 can interface to Desktop Servlet 204. The Access Device can be a mobile phone, a PDA, or any appropriate computing device. The Desktop Servlet can present the front page, which can contain an assortment of channels of content and the like, to the Access Device. Desktop Servlet 204 can interface to Mobile Desktop Dispatcher 206. Based on the type of Access Device and the configuration of the portal, a request from the Access Device can be sent to Device-specific Containers 208 and/or Rendering Container 210. There can be a number of Device-specific Containers representing instances for different types of devices, such as Nokia or Siemens type mobile phone devices. Rendering Container 210 can include AML templates from the content providers. The containers can act to aggregate and present the content in a format suitable for a particular application or Access Device type. Rendering Container 210 can aggregate content from Providers 212 and/or Rendering Provider 214. Rendering Container 210 can also interface to Rendering Engine 216. The Rendering Engine can receive a document in AML format and translate the document into a device-specific markup language. Providers 212 can be “native” Providers that can interface to the Device-specific Containers 208 and/or Rendering Container 210. Non-rendering providers can be designated for Access Devices supported by the Portal Server and can generate device-specific markup language instead of a generic language, such as AML. Rendering Provider 214 can interface to Device-specific Containers 208 and/or Rendering Container 210. The Rendering Provider can provide content in AML format.

According to an embodiment, in one mode of operation, a request can arrive via the Access Device from an authenticated user to the Desktop Servlet. The Desktop Servlet can begin to form the front page, but the proper format suitable for the Access Device must be determined. Based on the type of Access Device and/or on the configuration of the Portal Server, a request may be forwarded to the Rendering Container, for example. The term “rendering” as used herein implies the use of AML-based templates. The Rendering Container must be able to present the different channels desired based on the Access Device type and/or configuration. The content of the channels themselves can be generated by a provider, which can include content from a non-rendering provider 212 or a Rendering Provider 214. Non-rendering providers 212 can generate actual content in a device-specific format, but Rendering Provider 214 can generate actual content in AML, or a suitable generic language, format. The providers can give their content to the containers for aggregation. A container, such as Rendering Container 210 can include information or copies of content from different providers and can present an integrated view of a document in AML format. A post-processing step may be used to convert an AML document into a device-specific markup document. Such post-processing can occur when Rendering Container 210 calls Rendering Engine 216, which can convert the document into whatever markup is needed for presentation to Access Device 202. For a document received in AML format, Rendering Engine 216 can translate the document based on the type of Access Device 202. Thus, different markups can be sent back from Rendering Engine 216. For example, if the Access Device is a Nokia phone, WML can be sent back from Rendering Engine 216. The type of Access Device can be distinguished and the Rendering Engine can return the appropriate markup. The post-processed content can then go back to the Rendering Container 210 and out to the Access Device 202.

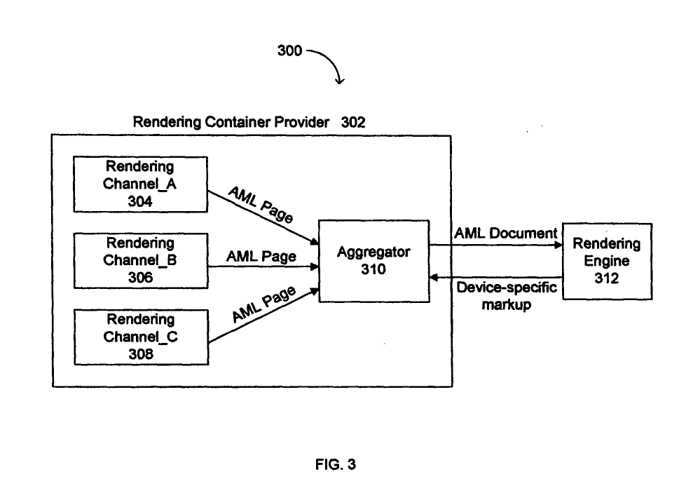

Depending on the type of Access Device and/or the configuration of the Portal Server, channels of content can come from device-specific or “non-rendering” providers and/or via the Rendering Provider path. As an example of a device-specific file path, a Nokia 6310 file path may include wml/Nokia/6310 whereas a rendering provider may follow a file path according to aml/wml/Nokia/6310. Both Device-specific Containers 208 and Rendering Container 210 can accommodate a mix of “rendering” and “non-rendering” channels, as will be described in more detail below with reference to FIG. 2 along with FIGS. 3-5.

The flexibility in allowing combinations of channels from non-rendering providers 212 as well as from Rendering Provider 214 is one advantage of the embodiments. A particular configuration may designate the device-specific path for optimized performance in cases where certain types of Access Devices are known. For example, a commonly used Nokia type of mobile phone can be supported by a configuration whereby its content is generated by a non-rendering provider via a Device-specific Container 208. Because no post-processing step is needed for this example, there is less translation involved and the access path can be optimized for performance. Also, because Nokia contains a large market share, it may be considered worth the effort to develop Nokia-specific containers. However, this would not necessarily be the case for newer types of PDAs where the market is not yet developed. For these cases, a rendering approach from an AML type document may be preferred because only the rendering or “back-end” would need to be changed to accommodate a device in this category. Further, because there is currently an installed portal base with many customers, there already are many Device-specific Containers available. Accordingly, the ability to integrate the Rendering Provider 214 information with Device-specific Containers 208 through Rendering Container 210 can be important. In such an approach, the aggregated document can then be translated via Rendering Engine 216.

Referring now to FIG. 3, a block diagram of an example rendering container provider for all rendering type channels according to an embodiment is shown and indicated by the general reference character 300. This diagram represents the Rendering Provider and Rendering Container interaction as Rendering Container Provider 302 and the associated interaction with Rendering Engine 312. In this example, Rendering Channel_A 304, Rendering Channel_B 306, and Rendering Channel_C 308 all can send information in AML format (“AML Page”) to Aggregator 310. The Aggregator can send the AML Document to Rendering Engine 312 for conversion into Device-specific markup. This example corresponds to a full (i.e., not mixed) rendering path including Rendering Container 210, Rendering Provider 214, and Rendering Engine 216, of FIG. 2.

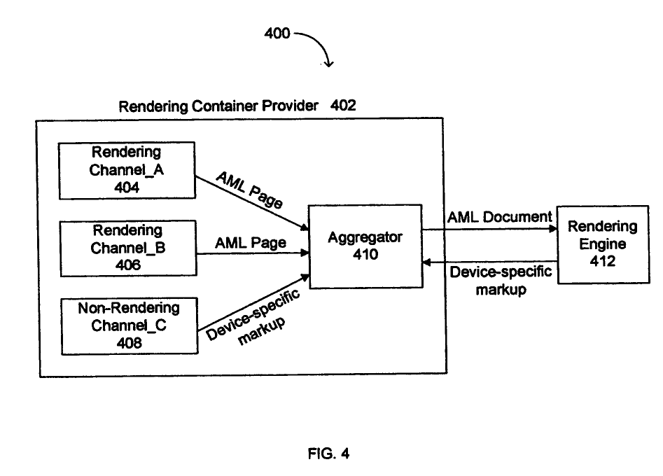

Referring now to FIG. 4, a block diagram of an example rendering container provider for two rendering type channels and one non-rendering type channel according to an embodiment is shown and indicated by the general reference character 400. This diagram represents the Rendering Provider, non-rendering provider, and Rendering Container interaction as Rendering Container Provider 402 and the associated interaction with Rendering Engine 412. In this example, Rendering Channel_A 404 and Rendering Channel_B 406 can send information in AML format (“AML Page”) to Aggregator 410. However, Non-Rendering Channel_C 408 can send information in Device-specific markup to Aggregator 410. The Aggregator can then send an aggregated AML Document to Rendering Engine 412 for conversion into Device-specific markup. This example corresponds to a mixed rendering/non-rendering path aggregated by Rendering Container 210 of FIG. 2. This example path includes Providers 212, Rendering Provider 214, Rendering Container 210, and Rendering Engine 216, of FIG. 2.

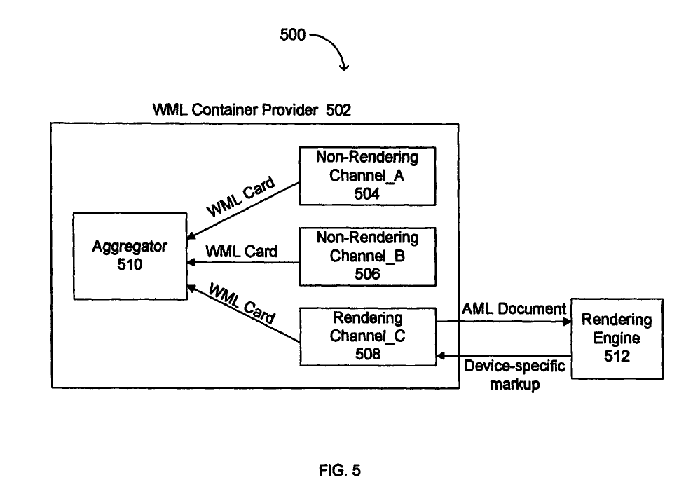

Referring now to FIG. 5, a block diagram of an example WML container provider for two non-rendering type channels and one rendering type channel according to an embodiment is shown and indicated by the general reference character 500. In this example, the aggregation is done in a Device-specific Container where the device uses WML. This diagram represents the Rendering Provider, non-rendering provider, and Device-specific Container (e.g., Nokia) interaction as WML Container Provider 502 and the associated interaction with Rendering Engine 512. In this example, device-specific channels, Non-Rendering Channel_A 504 and Non-Rendering Channel_B 506, can send information in WML format (“WML Card”) as its native format to Aggregator 510. However, Rendering Channel_C 508 must first have its information converted from AML to WML format. This is done by sending “AML Document” to Rendering Engine 512 for conversion into Device-specific markup, which is WML in this particular example. Rendering Channel_C 508 can then sent its WML Card to Aggregator 510. This example corresponds to a mixed rendering/non-rendering path aggregated by one of the Device-specific Containers 208 of FIG. 2. This example path includes Providers 212, Rendering Provider 214, Device-specific Containers 208, and Rendering Engine 216, of FIG. 2.

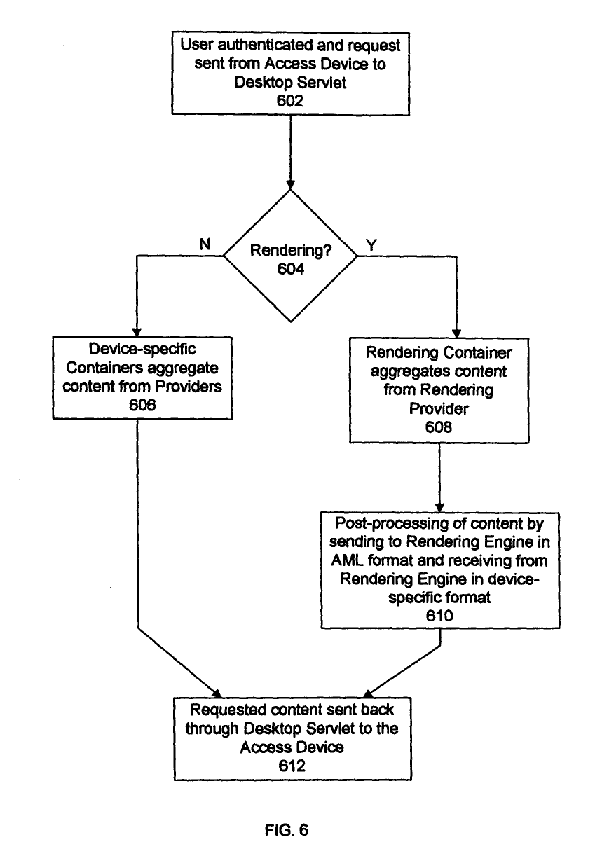

FIG. 6 shows a general diagram according to embodiments as a flow chart of a method of processing a request for content. Step 602 can include user authentication and the sending of a request for content from an Access Device to a Desktop Servlet. A Rendering decision branch 604 can determine, based on the system configuration and/or the type of Access Device, whether rendering is to be performed. If no rendering is to be performed, perhaps because Device-specific Containers exist in the portal, the Device-specific Containers can aggregate content from non-rendering providers in step 606. Then, the requested content can be sent back through the Desktop Servlet to the Access Device in step 612. If rendering is to be performed, the Rendering Container can aggregate content from the Rendering Provider in step 608. Next, a post-processing step can be performed to convert the content from AML to a device-specific format in step 610. Then, the requested content can be sent back to the Access Device in step 612. Of course, as discussed above with reference to FIGS. 3-5, various combinations of rendering and/or non-rendering channels can be provided according to embodiments.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order best to explain the principles of the invention and its practical application, thereby to enable others skilled in the art best to utilize the invention and various embodiments with various modifications as are suited to the particular use contemplated. It is intended that the scope of the invention be defined by the claims appended hereto and their equivalents.

1. A method for providing client aware content aggregation and rendering in a portal server, comprising:
receiving content from a plurality of channels;
aggregating the content from the channels using an aggregator, the aggregator configured to process the content using a first markup language;
processing the aggregated content using a rendering engine, the rendering engine configured to output the aggregated content in a second markup language tailored for a client device; and
outputting the aggregated content in the second markup language to the client device.

2. The method of claim 1, wherein the first markup language is AML (abstract markup language).

3. The method of claim 1, wherein the second markup language is a device specific markup language in accordance with the requirements of the client device

4. The method of claim 1, wherein the content received from a plurality of channels includes AML based pages

5. The method of claim 1, wherein the content received from at least one of the plurality of channels includes content in the second markup language

6. A method of processing a request for content from an access device, comprising:
providing a first channel having content in a first markup language;
providing a second channel having content in the first markup language;
aggregating the first channel content with the second channel content to form a first document in the first markup language; and
post-processing the first document to form a second document in a second markup language.

7. The method according to claim 6, wherein:
the first and second channels each include a rendering channel.

8. The method according to claim 6, wherein:
the first channel includes a rendering channel; and
the second channel includes a non-rendering channel having content in the second markup language.

9. The method according to claim 8, wherein:
the post-processing includes transforming a document from the first channel in a first markup language into a document returned to the first channel in the second markup language.

10. The method according to claim 3, wherein:
the first markup language includes a generic type of markup language.

11. The method according to claim 10, wherein:
the generic type of markup language includes abstract markup language (AML).

12. The method according to claim 3, wherein:
the second markup language includes a device-specific markup language.

13. The method according to claim 3, wherein:
the post-processing includes using a rendering engine.

14. A computer system configured to execute software to process a request for content from an access device, comprising:
a first channel having content in a first markup language;
a second channel having content in the first markup language;
an aggregation of the first channel content with the second channel content to form a first document in the first markup language; and
a post-processing of the first document to form a second document in a second markup language.

15. The computer system according to claim 14, wherein:
the first and second channels each include a rendering channel.

16. The computer system according to claim 14, wherein:
the first channel includes a rendering channel; and
the second channel includes a non-rendering channel having content in the second markup language.

17. The computer system according to claim 16, wherein:
the post-processing includes transforming a document from the first channel in a first markup language into a document returned to the first channel in the second markup language.

18. The computer system according to claim 17, wherein:
the first markup language includes a generic type of markup language.

19. The computer system according to claim 18, wherein:
the generic type of markup language includes abstract markup language (AML).

20. The computer system according to claim 14, wherein:
the second markup language includes a device-specific markup language.

21. The computer system according to claim 14, wherein:
the post-processing includes using a rendering engine.

22. A machine readable medium having embodied thereon a computer program for processing by a machine, the computer program comprising:
code for providing a first channel having content in a first markup language;
code for providing a second channel having content in the first markup language;
code for aggregating the first channel content with the second channel content to form a first document in the first markup language; and
code for post-processing the first document to form a second document in a second markup language.

23. The machine readable medium according to claim 22, wherein:
the first and second channels each include a rendering channel.

24. The machine readable medium according to claim 22, wherein:
the first channel includes a rendering channel; and
the second channel includes a non-rendering channel having content in the second markup language.

25. The machine readable medium according to claim 24, wherein:
the post-processing includes transforming a document from the first channel in a first markup language into a document returned to the first channel in the second markup language.

26. The machine readable medium according to claim 22, wherein:
the first markup language includes a generic type of markup language.

27. The machine readable medium according to claim 26, wherein:
the generic type of markup language includes abstract markup language (AML).

28. The machine readable medium according to claim 22, wherein:
the second markup language includes a device-specific markup language.

29. The machine readable medium according to claim 22, wherein:
the post-processing includes using a rendering engine.
